(19) United States
(12) Patent Application Publication
(10) Pub. No.: US 2006/0184517 A1
(43) Pub. Date: Aug. 17, 2006

(54) Answers analytics: computing answers across discrete data

(75) Inventors: Chris W. Anderson, Renton, WA (US); Edward David Harris, Bellevue, WA (US); Jamie P. Buckley, Redmond, WA (US); Laura J. Baldwin, Seattle, WA (US); Randall F. Kern, Seattle, WA (US)

Correspondence Address: SHOOK, HARDY & BACON L.L.P.;(c/o MICROSOFT CORPORATION), 2555 GRAND BOULEVARD, KANSAS CITY, MO, 64108-2613, US

(73) Assignee: Microsoft Corporation, Redmond, WA (US)

(21) Appl. No.: 11/341,512

(22) Filed: Jan. 30, 2006

Related U.S. Application Data
(63) Continuation-in-part of application No. 11/059,014, filed on Feb. 15, 2005.

(51) Int. Cl. G06F 17/30; G06F 7/00

(52) U.S. Cl. 707/3

(57) ABSTRACT

A method to derive new facts from a collection of discrete facts is provided. The discrete facts are stored in a data structure that organizes each discrete fact based on classification, value, unit, validity range, and subject. The discrete facts may be stored in an inverted index to allow efficient retrieval of values associated with each discrete fact. A discrete-fact engine is utilized in conjunction with a search engine to respond to queries. The discrete-fact engine parses a query and utilizes a collection of policies to determine whether the query involves a computational requirement. The computational requirement included in the query may trigger calculations on a set of discrete facts that match terms included the query. The result of the calculations are derived facts.

### CROSS-REFERENCE TO RELATED APPLICATION

This application claims priority under 35 U.S.C. §120 and is a continuation-in-part application of a non-provisional application, entitled “Search Methods And Associated Systems,” U.S. application Ser. No. 11/059014, filed Feb. 15, 2005.

### STATEMENT REGARDING FEDERALLY SPONSORED RESEARCH OR DEVELOPMENT

Not applicable.

### BACKGROUND

Currently, search engines provide results based on terms included in a query. The search engines may return biased results, which may not have technical or factual accuracy required by a user. Some single-domain search engines have attempted to specialize in storing and retrieving results having technical or factual accuracy. The single-domain search engines allow the user to retrieve reliable information from a chosen domain.

For instance, a user may go to ESPN.com to retrieve reliable information on sports. A user may utilize the ESPN.com interface to navigate statistical information related to a team or player of interest. Here, the sports information is stored in a format that does not easily derive new information. The type of queries that are answered is limited to the chosen domain and the storage format. In other domains, such as, finance or cooking, the queries limited to questions included in a drop-down box or frequently asked questions section, where a set of pre-defined queries is listed. The finite set of pre-defined queries is associated with answers that may not fully resolve a users need for information. Accordingly, the answers returned by these systems are limited, and the systems lack cross-domain search capabilities. A user looking for factual information during a specified time period, in the finance and sports domains would have difficulty determining the relevant facts in the two different domains.

### SUMMARY

In an embodiment, a method for deriving facts from a collection of discrete facts is provided. The collection of discrete facts may represent information from multiple domains. The information associated with the multiple domains may be formatted to allow a query service to derive new information in response to a query having analytic terms.

A query specifying one or more terms is parsed to determine computational requirements associated with the query. Policies are utilized to parse the query and to generate additional queries on a discrete-fact index. The discrete-fact index is searched to locate discrete facts associated with terms included in the query. A fact set is created and returned in response to the search. The fact set is further processed based on one or more calculations specified by the computational requirements to generate one or more derived facts, which are packaged and transmitted as a result of the query.

Additionally, the query may initiate web searches based on the terms included in the query. Web results based on the web search and the derived facts may be combined and transmitted in response to the query. Accordingly, a user may generate queries that return derived facts and web results.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is network diagram that illustrates an exemplary computing environment, according to embodiments of the invention;

FIG. 2 is a block diagram that illustrates a discrete-fact engine utilized by embodiments of the invention;

FIG. 3 is a format diagram that illustrates a data structure providing information on discrete facts utilized by embodiment of the invention;

FIG. 4 is a relationship diagram that illustrates the relationships between discrete facts according to embodiments of the invention;

FIG. 5 is a flow diagram that illustrates a method to derive facts according to embodiments of the invention; and

FIG. 6 is a schematic illustration of a portion of a rule set utilized to parse a query according to embodiments of the invention.

### DETAILED DESCRIPTION

Embodiments of the invention provide a method to generate derived facts from a collection of discrete facts. A discrete-fact engine receives queries and applies policies to determine an appropriate action. The queries are parsed and additional queries are generated to locate discrete facts matching terms included in the queries. The queries may include analytic terms that specify computational requirements. The analytic terms are used to select appropriate calculations. The matching discrete facts are grouped into fact sets and the selected calculations are performed on the fact sets. The results of the calculations are derived facts, which are transmitted in response to the query. Accordingly, embodiments of the invention utilize the discrete-fact engine to generate derived facts from the collection of the discrete facts. The discrete-fact engine may include analytic components, which define the set of calculations that may be performed on the discrete facts, and policy components, which define rules for parsing the queries.

A system that generates derived facts from a collection of discrete facts may include one or more computers that have processors executing instructions associated with generating derived facts. The computers may include inverted indices that store discrete facts. A collection of discrete facts may include one or more properties that define the discrete facts. The processors may include discrete-fact or search engines that receive the queries and generate results based on the terms included in the queries. In an embodiment of the invention, the processors may be communicatively connected to client devices through a communication network, and the client devices may include a portable device, such as, laptops, personal digital assistants, smart phones, etc.

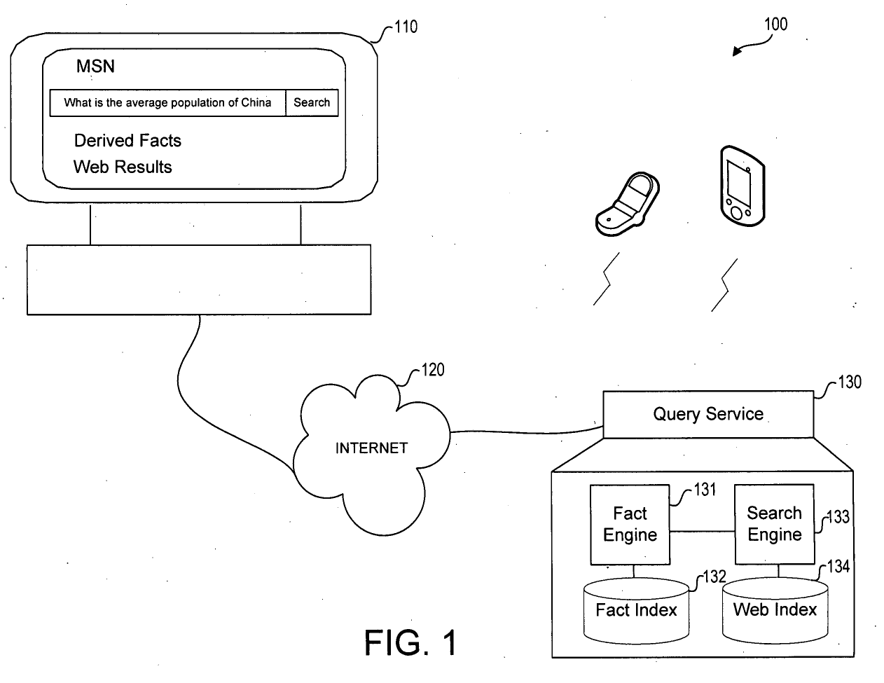

FIG. 1 is network diagram that illustrates an exemplary computing environment 100, according to embodiments of the invention. The computing environment 100 is not intended to suggest any limitation as to scope or functionality. Embodiments of the invention are operable with numerous other special purpose computing environments or configurations. With reference to FIG. 1, the computing environment 100 includes client devices 110, 140 and 150, server 130 and a communication network 120.

The client devices 110, 140, and 150 each have processing units, coupled to a variety of input devices and computer-readable media via communication buses. The computer-readable media may include computer storage and communication media that are removable or non-removable and volatile or non-volatile. By way of example, and not limitation, computer storage media includes electronic storage devices, optical storages devices, magnetic storage devices, or any medium used to store information that can be accessed by client devices 110, 140 and 150 and communication media may include wired and wireless media. The input devices may include, mice, keyboards, joysticks, controllers, microphones, cameras, camcorders, or any suitable device for providing user input to the client devices 110, 140 and 150.

In an embodiment of the invention, the client devices 110, 140 and 150 communicate with a server 130 that implements a query service. The server 130 provides access to a discrete-fact engine 131 and a search engine 133. The discrete-fact and search engines 131 and 133 may generate results, based on the terms specified in a query received by the query service. The discrete-fact engine 131 is coupled to a inverted index 132 that stores fact information, and the search engine 133 is connect to a web index 134 that stores information for locating multimedia files, such as images or web pages.

Additionally, the client devices 110, 140 and 150 may store application programs that provide computer-readable instructions to implement various heuristics Queries may be formulated by using applications stored on the client devices 110, 140 or 150. Client device 110 may be a desktop computer, where a user utilizes a browser application to connect to the server 130 and initiate a query. Also, the client devices 140 and 150 may be portable devices that utilize a mobile-browser application that enables mobile devices to wirelessly communicate through wireless access points. Accordingly, the client devices 140 and 150 may wirelessly connect to the server 130, where a query generated by the mobile-browser application is processed to generate appropriate answers. In an embodiment of the invention, the query may be a natural language query.

The communication network 120 may be a local area network, a wide area network, satellite network, wireless network or the Internet. The client devices 110, 140 and 150 may include laptops, smart phones, personal digital assistants, or desktop computers. The client devices 110, 140 and 150 utilize the communication network 120 to communicate with the server 130. The server 130 receives communications from the client devices 110, 140 and 150 and processes the communications to generate an answer. The computing environment 100 illustrated in FIG. 1 is exemplary and other configurations are within the scope of the invention.

In an embodiment, the query service provides access to a fact index that stores information about discrete facts. The discrete facts may include information on sports, money, history, cooking, geography, etc. The discrete facts are stored in an inverted index and organized to provide efficient access to values associated with the facts. The discrete facts are granular and store one value for each fact. In an embodiment, discrete facts utilize a subject, indicator, classification, value, unit, and validity range to organize the collection of discrete facts. The format of the discrete facts allows computations to be performed across a collection of the discrete facts that meet criteria included in a query. The discrete facts are received from trusted sources that ensure the accuracy of the information presented. In an embodiment of the invention, the discrete facts may be generated by a group of qualified experts, who verify the accuracy of the information.

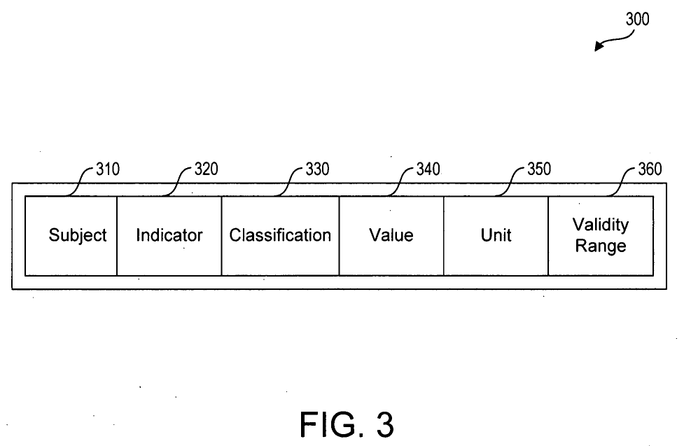

FIG. 3 is a format diagram that illustrates a data structure providing information on discrete facts utilized by embodiment of the invention. The discrete facts include a subject 310, indicator 320, classification 330, value 340, unit 350, and validity range 360.

The subject 310 provides information about whether the fact is a person, place or thing. In an embodiment of the invention, the subjects 310 may include proper nouns that describe an object. For example, Seattle is a subject. The subjects 310 utilize unique identifiers (not shown) to associate discrete facts with the subjects. In an embodiment, a subject 310 that utilizes a term that is a place and thing is associated with two separate identifiers.

The indicator 320 provides information about properties associated with the discrete fact or subject. The indicators 320 provide context for the fact associated with the subject 310. For example, population, size, and age are indicators that may be associated with a subject 3110. Indicators 320 have default display units that the display engine utilizes depending on the user or geographical locality. Also, indicators 320 have identifiers (not shown) that the discrete-fact engine utilizes when performing calculations to ensure that operations are performed on values related to the same indicator, but identifiers associated with the subjects or classifications may be different.

The classification 330 provides terms that are associated with multiple subjects 310. Classifications 330 are generalized groupings or names for the subject 310. Each subject 310 may have one or more classifications 330. Classifications 330 may utilize identifiers (not show) to associate the subjects with the classification. For example, Seattle may be classified as city. In an embodiment of the invention, the identifiers utilized by the indicators, subject and classification are numerical identifiers.

The value 340 provides a discrete value associated with the discrete fact. The value 340 may be a string, or numerical value based on the indicator 320 associated with the discrete fact. For example, the population of Seattle may be represented by a numerical value based on population information received from census data. Additionally, values 340 may be converted according to a user's display preferences.

The unit 350 provides the units associated with the value 340. The unit 350 for the value 340 may include inches, years, thousands of people, megapixels, etc. For example, the units associated with population of Seattle may be thousands of people. All facts with the same indicator must have values stored in the same unit 350 or must be convertible—the values 340 must be related through mathematical operations. The units 350 allow the discrete-fact engine to perform sound calculations based on the units 350 associated with the discrete facts. The units associated with the discrete fact may vary depending on the native units associated with the discrete fact. For example, a height of a foreign mountain may be stored in meters, while local mountains are stored in feet. Accordingly, units may be grouped into conversion sets, so the discrete-fact engine may properly convert the values before initiating the specified calculations.

The validity range 360 provides information on the validity of the value 340 associated with the indicator 320. Discrete facts may have a date range of negative infinity to infinity. For example, the height of Mt. Rainier is a discrete fact and has an infinite date range, but the population of Seattle is dynamic and may have a validity range 360 of three months. Discrete facts that have infinite validity ranges 360 are static facts, while facts with limited validity ranges 360 are dynamic facts. For instance, the dynamic fact a as age, may have a validity range 360 of a year, while a static fact, such as, color may have a validity range 360 of infinity. In an embodiment, the validity range 360 may be represented by a start and end date, where the date specifies a month, day or year. Also, queries may include a date term that requests facts that are associated with a specified time period. For example, a query may ask “what was the population in Seattle in 2002.” The discrete-fact engine may utilize the validity range 360 associated with the population of Seattle to filter facts that do not match the date criteria. Accordingly, embodiments of the invention provide discrete facts that are formatted to efficiently respond to queries received by a query service.

The queries formulated by a user of the client devices may be processed by a query service to generate answers or web results. The query service processes the queries by utilizing a discrete-fact engine and a search engine. Both engines may be incorporated on a single device. Alternatively, in an embodiment of the invention, the discrete-fact engine and the search engine may be incorporated on two separate devices that communicate with each other. Accordingly, the query service receives a query and simultaneously processes the query utilizing the search and discrete-fact engines. The results generated by each engine are combined and transmitted to the client devices.

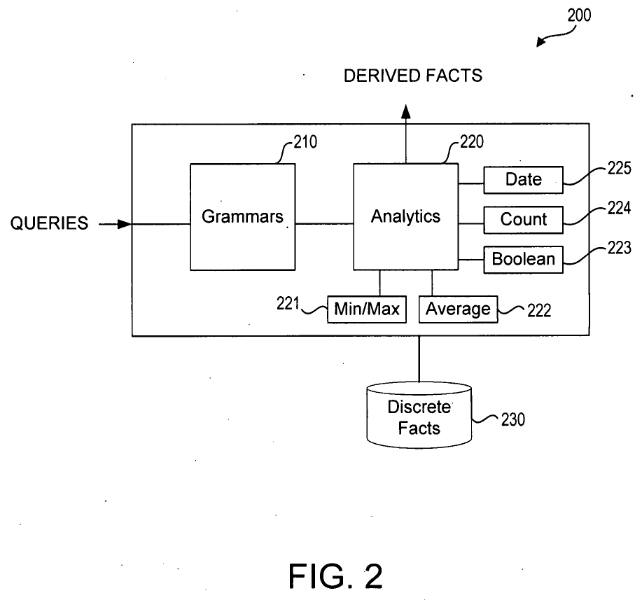

FIG. 2 is a block diagram that illustrates a discrete-fact engine 200 utilized by embodiments of the invention. The discrete-fact engine 200 receives queries and derives fact from a collection of discrete facts 230. The discrete-fact engine 200 includes a grammar component 210 and an analytic component 220. The grammar component 210 provides a set of policies that are utilized to parse queries received by the query service. The policies include rules that perform natural language analysis by detecting nouns, prepositions, subjects, indicators, and other fact properties. Generally, the policies attempt to enumerate various types of question formulations. In an embodiment of the invention, pattern-matching techniques are utilized to parse the query based on the rules. The pattern matching may use query structure to categorize terms included in the query as subject, indicator, analytic, etc. Accordingly, the grammar component 210 allows the discrete-fact engine to deduce subject, indicator or classification, and analytics from the query.

For example, a well-formed query may ask, “What is the average population of the North America?” The pattern-matching rule may look for a pattern having an interrogative pronoun, a verb form of “to be” and a preposition, which allows the discrete-fact engine to classify a term as subject or indicator. Here, the interrogative pronoun is “what,” “is” represents the form of “to be,” and the preposition “of” defines the relationship between the subject and indicator. In an embodiment, the discrete-fact engine determines which term of the query is the subject based on a frequency with which a term appears as a subject in previous queries, or based on a search on a fact-index to determine if the term is defined as a subject. Here, the subject is “North America,” the indicator is “population” and the analytic is “average.” The analytic is determined based on information included in the analytics component 220. Because a date was not specified, the discrete-fact engine includes a default validity range, which specifies that the facts must be current. Accordingly, executing the query causes the discrete-fact engine to perform searches on the collection of discrete facts 230 via multiple queries, which specify each state in North America and population, in turn the collection of facts 230 returns values for the population of each state. The analytics component 220 utilizes these values to sum the population values and divide the total by a count associated with the collection of facts to determine the current average population. Additionally, rules may specify that analytics, subjects, and indicators terms are the minimum requirements to perform a valid lookup in the discrete-fact index. If there is no pattern match, the query is processed by the search engine, and web results are returned to the user. Accordingly, the discrete-fact engine receives a query, utilizes one or more policies to perform a pattern match that parses the query into analytic, subject and indicator, or analytic, classification and indicator before generating derived facts from the collection of discrete facts 230 based on the analytic included in the query. In an embodiment of the invention, the grammars component 210 may include policies that are language dependent. Thus, different rules may be applied when the query is formulated in Japanese, German, Italian, etc.

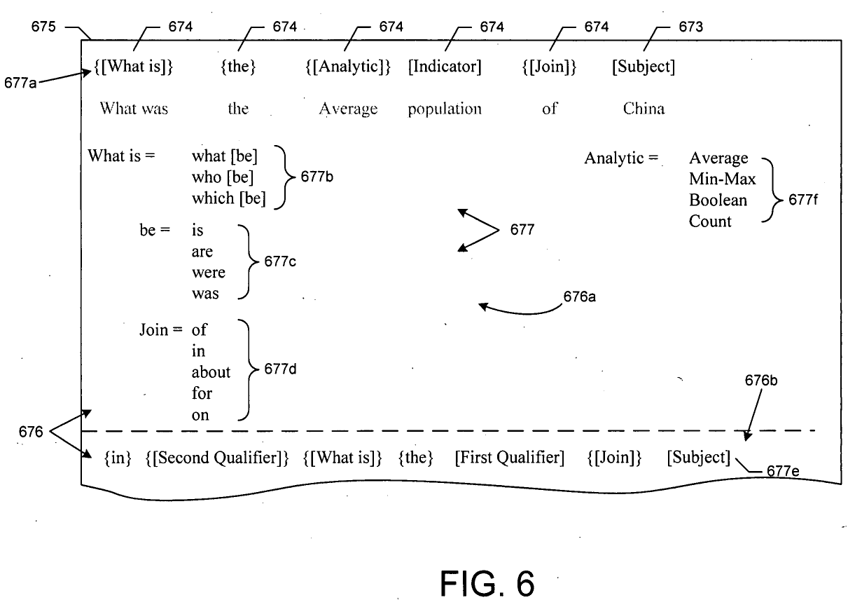

With reference to FIG. 6, a portion of a rule set 675 utilized to implement policies for parsing a query is illustrated. For example, the rule set 675 may include rules that govern or define the computer-implemented parsing process (e.g., the rule set can include context free grammar used to parse a query). The rule set 675 may include or one or more rule subsets 676. In certain embodiments, the rule set 675 can be stored in one or more computer accessible files and accessed one or more times during the parsing process. In the illustrated embodiment, the rule set 675 includes two rule subsets 676, shown as a first rule subsets 676a and a second rule subset 676b. The first rule subset 676a includes five rules 677, shown as a first rule 677a, a second rule 677b, a third rule 677c, a fourth rule 677d, and fifth rule 677f. The second rule subset 676b includes at least one rule 677, shown as a sixth rule 677e.

In the illustrated embodiment, the first and fifth rules 677a and 677e include patterns that can be compared with a query to find a pattern that matches the format of the query. In certain embodiments, the patterns can include multiple portions. The query term(s) and term(s) of the patterns may include various items including one or more word(s), letter(s), number(s), reference(s), or symbol(s). For example, the first rule 677a includes a subject term 673, an analytic 674, and an indicator 674. In other embodiments, the first rule 677a can have more or fewer terms.

In certain embodiments, selected portions of the patterns in the rules 677 may be optional. In order for a specific pattern to match the format of the query, the query can, but does not have to contain portions that match the optional portions of the specific pattern. In FIG. 6, optional portions are enclosed in braces (e.g., { }).

Additionally, in certain embodiments, selected terms of the pattern may include variable terms. In certain cases, the variable terms are limited to a selected number of specified items (e.g., specific word(s), letter(s), number(s), reference(s), or symbol(s)). In other cases, the variable terms can include any item. In FIG. 6, variable terms are enclosed in brackets (e.g., [ ]). In the illustrated embodiment, the second rule 677b, third rule 677c, fourth rule 677d, and sixth rule 677f define corresponding variable terms in the first rule 677a. In certain embodiments, these variable definitions can be used by other rules, such as, the fifth rule 677e. In other embodiments, these variable definitions can be stored in other locations, such as, for example, they can be stored in a separate subset of rules, a separate table, or a separate file. In still other embodiments, various patterns may have a dedicated set of variable term definitions.

In FIG. 2, the analytics component 220 provides a collection of calculations that may be performed based on the analytic terms parsed from the query. The analytics component 220 is utilized to perform the calculations on the fact sets generated by subsequent queries generated by the grammars component 210. By way of example and not limitation, the analytics component may provide min-max 221, average 222, boolean 223, count 224 and date 225 calculations. The analytics component 220 utilizes the calculations 221-225 to generate derived facts from the fact sets received from the collection of discrete facts 230.

The min-max calculation 221 may derive facts that answer questions relating to comparisons. Thus, the min-max calculation is utilized to answer questions, such as, “what is the longest river.” This type of query generates subsequent queries that return a fact set that includes discrete facts having values associated with rivers around the world. The min-max calculation 221 operates on the fact set to determine which of the discrete facts has the largest value. Similar actions are performed when a query attempts to find the smallest value associated with an indicator. Accordingly, questions that require comparisons between indicators of facts may utilize the min-max calculation to derive the new fact or answer to the query.

The average calculation 222 may derive facts that relate to averaging values associated with an indicator. In an embodiment of the invention, the average calculation 222 includes a sum calculation, which totals the value associated with a collection of facts. Thus, the average calculation 222 can answer queries that ask about a total associated with a common indicator associated with each discrete fact in a fact set, or an average associated with the common indicator across a fact set. For example, the average calculation 222 may answer queries that ask for the total population of North America, or the average populations of North America.

The boolean calculation 223, may derive facts that require a comparison among the values associated with indicators, where the comparison returns true or false, or yes or no answers. Typically, the boolean calculations 223 are utilized when a query requires comparisons between two different subjects. Furthermore, the boolean calculation 223 may be utilized to perform calculations on derived facts.

The count calculation 224 may derive facts that count the number of facts that meet a specified condition. For example, the count calculation 224 may provide answers to queries that ask “how many Mariners have a batting average over 250.” Also, this transformation is utilized by the average calculation 222 to determine the count associated with the fact set.

The date calculation 225 derives facts from the facts that answer questions that deal with temporal queries. The date calculation 225 may derive facts that specify a date or date range. For example, the date calculation 225 may be utilized to answer queries, such as, “when was the Great Pyramid built,” or “how old is Elvis.”

Additionally, complex queries may utilize multiple calculations to derive a result. The complex queries provide the user with the ability to compare facts across different domains. The calculations performed by the discrete-fact engine utilizes the units associated with each discrete fact to make the appropriate conversions. Thus, the discrete-fact engine ensures that the calculations performed on a fact set are mathematically sound.

When a query does not include an analytic, the best fact associated with terms included in the query is returned. The best fact may be the most relevant based on rank or based on the validity date range associated with the facts.

The queries may include various computational requirements, however some computational requirements may allow the discrete-fact engine to infer mathematical operations or other information based on the scope of the query received. When the user initiates a broad query, the scope of the query is refined by utilizing default values that may help the discrete-fact engine to properly process the query. The default values may fill information on date validity. Thus, when a query is not fully qualified, default values are used to enable the discrete-facts engine to process the query. Furthermore, based on the analytic terms included in the query the discrete-fact engine may perform a group of calculations on the collection of discrete facts. Accordingly, embodiments of the invention provide a means to answer queries, such as “how many digital cameras cost less than 300 dollars and have a resolution over 3 megapixels.”

The discrete facts may be stored in a hierarchical data structure to efficiently represent the relationships shared among discrete facts stored in the inverted fact index. The relationship information may be utilized by the discrete-fact engine to efficiently access the discrete facts associated with relationships, such as, parent-child relationships. Also, a hierarchical data structure may be utilized capture relationships between subjects and classifications. Furthermore, the relationships may include validity ranges that represent the temporal attributes associate with the discrete facts. The relationships include alternates that provide equivalent representations of a subject or classification.

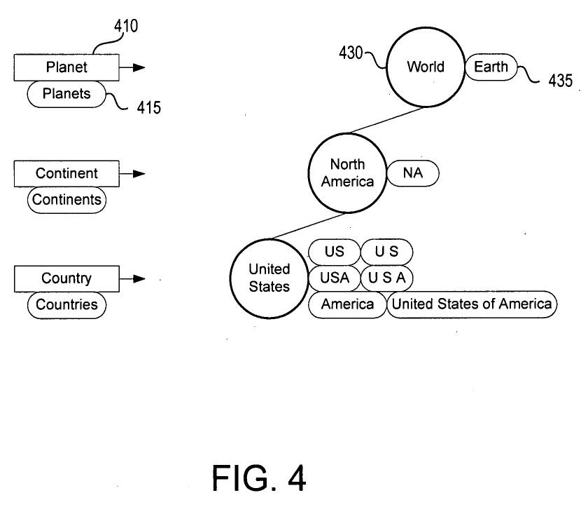

FIG. 4 is a relationship diagram that illustrates the relationships between discrete facts according to embodiments of the invention. Each discrete fact is associated with a classification 410, subject 430, or alternate 435. For instance, the subject World 430 is associated with the alternate earth 435 and classification planet 410 is associated with an alternate 415. Subjects 430 may be related via parent-child relationships and each parent is associated with one or more classifications 410 or alternates 415. The relationships between subjects 430 may be represented vertically through parent-child relationship and the relationships between classifications 410 and subjects 430 may be represented horizontally through groups. Accordingly, the discrete-fact engine may utilize the relationships to efficiently process queries that require finding values associated with related discrete facts.

The query service may receive natural language queries or a selection of query terms. The query terms are parsed to determine whether the discrete-fact engine is able to derive an answer or whether web results are the best answer. In an embodiment of the invention, the query service provides derived facts and web results when possible. The results of the query may be cached for a specified time period to reduce the computational load of the query service.

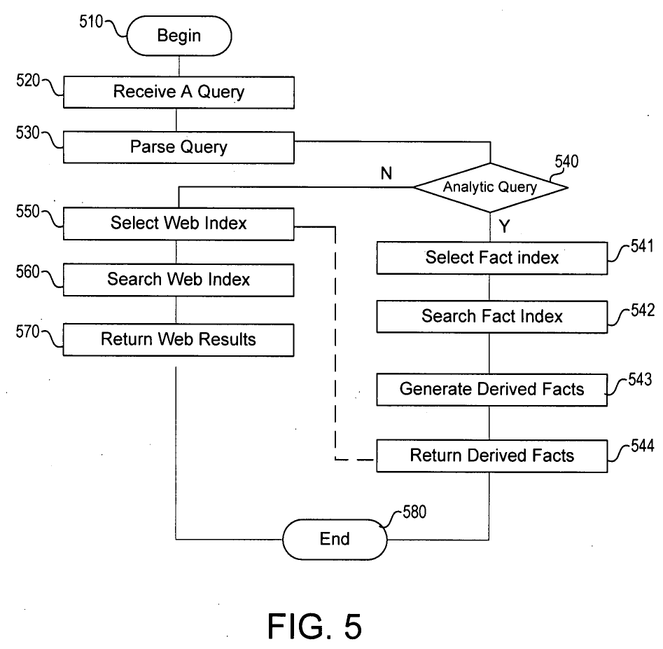

FIG. 5 is a flow diagram that illustrates a method to derive facts according to embodiments of the invention.

The method begins in step 510, when a query is transmitted to a query service. In step 520 the query is received by the query service. In step 530 the query is parsed based on the policies implemented by the query service. In step 540 the parsed query is checked to determine whether the query is an analytic query. When the query is an analytic query, the fact index is selected in 541. The parsed query generates additional queries that are utilized to search the discrete-fact index in step 542. The results of the search are stored in fact sets and appropriate computations are performed based on the type of analytics detected in the query to derive new facts in step 543. The derived facts are returned in step 544.

In an embodiment where the parsed query does not contain analytics, the web index can be selected in step 550. The web index can then be searched utilizing the parsed query in step 560. Web results are returned in step 570. The method ends in step 580.

In an alternative embodiment, when the derived facts are returned to the end user in step 544, the process may issue the query to the web index and generate web results. In such an embodiment, the derived facts and web results are returned to the end user.

In sum, a collection of discrete facts is utilized to derive new facts. The new facts are generated in response to queries that include one or more analytic terms. The analytic terms initiate calculations on values associated with the discrete facts. The values are processed and formatted for transmission to the users initiating the queries. Alternate embodiments of the invention, may include a system for deriving new facts. The system may include a discrete-fact engine that includes a grammar and analytics component. The discrete-fact engine receives the queries and utilizes the grammar component to parse the queries. The parsed queries create additional queries that are issued to the collection of discrete facts and the analytics component performs a set of calculations the values associated with fact set generated in response to the queries to create answers or derived facts.

The foregoing descriptions of the invention are illustrative, and modifications in configuration and implementation will occur to persons skilled in the art. For instance, while the present invention has generally been described with relation to FIGS. 1-6, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

We claim:

1. A method of executing analytical queries on a collection of facts, the method comprising:
receiving a query;
parsing the the query;
searching the collection of facts based on terms included in the parsed query to generate a subset of the collection of facts;
performing one or more calculations on the subset of the collection of facts; and
returning results of the one or more calculations.

2. The method according to claim 1, wherein the query is a natural language query.

3. The method according to claim 1, wherein the one or more computations are inferred from the query.

4. The method according to claim 1, wherein the results are rendered based on geographical locality and user locality.

5. The method according to claim 1, wherein the results are filtered to generate an answer having the highest relevance.

6. The method according to claim 1, wherein the results include derived facts having validity ranges.

7. The method according to claim 6, further comprising: p1 combining the derived facts with web results.

8. The method according to claim 1, wherein a web search is initiated, if the query fails to generate derived facts.

9. The method according to claim 8, wherein parsing the query further comprises:
performing a pattern match based on rules having analytics.

10. A method to derive new facts from an existing collection of discrete facts, the method comprising:
receiving a query having an analytic portion;
performing a pattern match to parse the query and to determine computational requirements;
generating additional queries based on the parsed query;
creating fact sets that match the additional queries;
performing calculations on the fact sets based on the computational requirements; and
returning results of the calculations.

11. The method according to claim 10, wherein each fact of the collection of discrete facts includes a unit, value, subject and indicator.

12. The method according to claim 10, wherein the collection of discrete facts is stored in an inverted index.

13. The method according to claim 10, wherein the derived facts are cached based on validity ranges associated with the derived facts.

14. The method according to claim 10, wherein default values are utilized when a query is not fully qualified.

15. The method according to claim 10, wherein the query is a natural language query.

16. The method according to claim 10, wherein the collection of discrete facts include facts from a variety of domains.

17. A method to derive facts from discrete facts, the method comprising:
receiving a web query;
parsing the web query to determine whether a computational requirement is present;
selecting an index to search based on the parsed query;
searching the selected index to generate a fact set; and
utilizing the computational requirement to perform calculations on the fact set.

18. The method according to claim 17, wherein selecting an index to search based on the parsed query further comprises:
selecting at least on of a collection of facts or a collection of web pages.

19. The method according to claim 17, wherein the web query is a natural language query.

20. The method according to claim 17, wherein the results include web results and derived facts.
